(19) United States
(12) Patent Application Publication
(10) Pub. No.: US 2022/0188907 A1
(43) Pub. Date: Jun. 16, 2022

(54) ECOMMERCE MARKETPLACE WITH CUSTOM PURCHASE ORDER

(71) Applicant: Amazon Technologies, Inc., Seattle, WA (US)

(72) Inventors: Ankur Anand, Hyderabad (IN); Vikash Kumar Jain, Hyderabad (IN); Satya S. Mishra, Redmond, WA (US); Neha Goswami, Bellevue, WA (US)

(73) Assignee: Amazon Technologies, Inc., Seattle, WA (US)

(21) Appl. No.: 17/119,267

(22) Filed: Dec. 11, 2020

(51) Int. Cl. G06Q 30/06; G06Q 10/06

(52) U.S. Cl. CPC G06Q 30/0635; G06Q 10/0631

(57) ABSTRACT

In B2B purchasing, ordering is proposed wherein a customer can buy directly from a supplier website without logging into their own E-procurement system. In one embodiment, the supplier website generates a customized purchase order (PO) for submission to a third-party's purchasing system based upon purchases made by the customer. The purchasing system sends an acknowledgement, and the supplier can proceed to fulfil the order.

### BACKGROUND

In a business-to-business (B2B) E-commerce context, business customers often use online supplier marketplaces to purchase products directly from other businesses or the B2B goods suppliers. For example, businesses can purchase office supplies, manufacturing parts, janitorial supplies, and other products directly from other businesses. B2B customers often use their home grown or 3P procurement systems (also referred to as E-procurement systems, spend management systems, punchout systems, supplier management portals, travel & expense management systems, etc.) to manage such procurement needs. Such systems are integrated with the supplier's marketplace to allow their employees or authorized users of the procurement systems to make purchases from the supplier's marketplace through such procurement systems. The use of such systems allows for greater visibility and control into the organization's purchases and for compliance with internal policies of the businesses.

For example, users can log into the 3P procurement system, then via links in the 3P system (e.g., via a click button), login into the supplier's marketplace (e.g., supplier system). Once they are on the supplier marketplace, the user then searches for the items to buy and builds a shopping cart of these items. This method of accessing a supplier's web-catalog, E-commerce website, or marketplace from within the B2B customer's procurement system is often referred to as “Punchout.” Once a customer “punches out” and builds the cart on the supplier's website, the user then transfers the cart back to their procurement system. Thus, the customer's employees can access and shop in an E-commerce website without leaving the customer's platform. After the shopping cart is received back in the customer's procurement system, the customer performs administrative actions within the procurement system to send the cart for approval to their supervisor, who approves the cart. After approval, the procurement system sends a purchase order to the supplier system.

### BRIEF DESCRIPTION OF THE DRAWINGS

FIG. 1 is a system diagram, according to a first embodiment, for ordering products directly through a supplier website with punchoutless ordering.

FIG. 2 is a flow diagram according to one embodiment for performing punchoutless ordering.

FIG. 3 is a flow diagram according to another embodiment for performing punchoutless ordering.

FIG. 4 is a flow diagram according to yet another embodiment for performing punchoutless ordering.

FIG. 5 is a flow diagram according to yet another embodiment for performing punchoutless ordering.

FIG. 6 depicts a generalized example of a suitable computing environment in which the described innovations may be implemented.

### DETAILED DESCRIPTION

In Punchout, a buyer has to login to the third-party purchasing system associated with a company. From within the system, the buyer accesses the supplier catalog or E-commerce website. There is a desire to allow employees of the company to buy directly from the supplier's E-commerce website. In B2B purchasing, ordering is proposed wherein a customer can buy directly from a supplier website without logging into their own E-procurement system. In one embodiment, the supplier website allows the buyer to place a purchase order (PO) directly on the supplier website, and routes this purchase order through the buyer's purchasing system for reconciliation and approval. For example, the buyer's purchasing system can include an E-procurement system, an enterprise resource planning (ERP) system and other financing systems. The PO can be sent directly to any of these subsystems within the purchasing system. The purchasing system sends an acknowledgement, and the supplier can proceed to fulfil the order. This flow allows the customer to access a supplier website outside of VPN to provide more flexibility and the ability to enforce policies and controls.

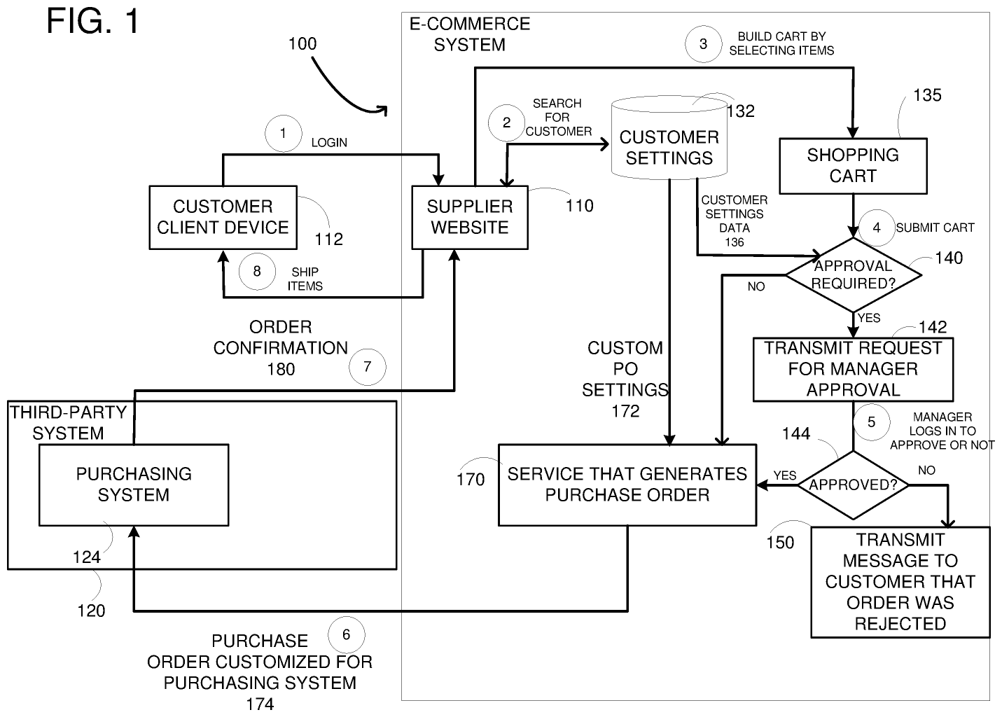

FIG. 1 shows a first embodiment of a system 100 for ordering products directly through an E-commerce system 100 including a supplier website 110. A customer operating a client device 112 accesses the supplier website 110 of the E-commerce system 100. The supplier website 110 is an online marketplace allowing consumers and businesses to purchase products using E-commerce. The supplier website 110 is typically executing on a plurality of server computers within the E-commerce system 100. The customer is an employee of a company operating a third-party system 120 that requires approvals of purchases made by the customer on behalf of the business. The third-party system 120 is associated with a company and includes a purchasing system 124. The purchasing system 124 can include, for example, an E-procurement system, an ERP system, etc. The E-procurement system is a business-to-business system for the purchase and sale of products through a website over the Internet. The E-procurement system has functionality for catalogue management, purchase order integration, invoicing, payment, etc. The ERP is software that manages day-to-day business activities, such as accounting, procurement, and supply-chain operations. The ERP can also be used to budget, predict and report on financial results. Further, the ERP system can track and maintain the status of business orders, purchase orders and payroll.

The client device 112 can be any client device, such as a mobile phone, tablet, laptop computer, etc. Notably, the customer operating the client device 112 does not login to the third-party system 120 and access the supplier website 110 through the third-party system. Instead, the customer operating the client device 112 logs directly into the supplier website 110. The E-commerce system 100 further includes a database 132 for storing customer settings. For example, an administrator of the third-party system 120 configures a customer business account in the database 132 for enabling purchasing directly (i.e., without logging into the third-party system) from the E-commerce system 100. The administrator further provides an identification strategy allowing the E-commerce system to identify the customer 112 as associated with the third-party system 120. Example, identification strategies include using a user-specific unique identifier (Email ID, Mobile Number, third-party common keys, cookie, token, etc.), SSO details or Third-Party authentication and authorization. Other configurations performed by an administrator of the third-party that are stored in the database include defining a template to use in generation of a purchase order (PO), providing an authentication technique to be used for communications between a supplier and the third-party system, etc. Other configurations can be used. In order to configure the customer settings 132, an administrator of the third-party system 120 can submit the settings to the supplier website 110. The supplier website 110 can then populate the customer settings in the database 132.

In order to further understand interactions between the customer client device 112, the third-party system 120 and the supplier system 110, circled numbers are indicated relating to example steps that can occur. At 1, a customer using the customer client device 112 logs directly into a supplier website 110 to purchase goods, just the same as a general consumer (unaffiliated with the third-party system) logs into the supplier website 110. The customer login is typically using credentials associated with a business account. At 2, the supplier website 110 searches the customer login details in the database 132, such as by searching using a parameter of the credentials as a key (e.g., an email address). If a match is found, then the supplier website 110 identifies the customer as associated with the third-party system 120. Other business account details and setup properties are also retrieved from the database 132. At 3, the customer creates a shopping cart 135 on the supplier website 110, such as by placing one or more products in a shopping cart for purchase. The shopping cart is software that includes identifiers associated with products to purchase. At 4, the customer submits the shopping cart 135 for purchase and the E-commerce system 100 checks the previously retrieved properties (shown as customer settings data 136). If the customer is associated with the third-party system, then the customer settings data is checked at 140 to determine whether a manager needs to approve the purchase of the products in the shopping cart 135. If approval is required, then at 142, a message (e.g., email, text, etc.) is sent to the manager requesting approval of the shopping cart. At 5, the manager logs into the supplier website 110 and approves the purchase at 144. Alternatively, if the manager rejects the purchase, then at 150, a message is transmitted to the customer informing the customer that the order was rejected.

If decision block 140 is answered in the negative (no approval required) or decision block 144 is answered in the affirmative (manager approved), then a service 170 generates a PO in conformance with custom PO settings 172 from the database 132. The custom PO settings can include a template used by the service 170 to customize the PO for the purchasing system 124. The template can take any form, but one potential format is under the cXML format for transmitting purchase orders. Other formats include ANSI X.12 Electronic Data Interchange. At 6, the service 170 generates the PO in conformance with the settings 172 and transmits the PO directly to the purchasing system 124 of the third-party system 120, as shown at 174. The PO can include identifiers of the products to be purchased, an account code, a project code, or any other desired custom data. In prior art systems, it is the E-procurement system that generates the PO. Having a service within the E-commerce system 100 generate the PO provides benefits in that the customer can log directly into the supplier website 110 and obtain approval from the purchasing system 124 within seconds of the service 170 transmitting the PO. A Punchout Order Message (POOM) is not generated. The purchasing system 124 can reject the PO. For example, the purchasing system can have controls over which users can purchase or not, which product categories are acceptable or not, and which specific products are acceptable or not. However, if the purchasing system 124 approves the order, then at 7, an order confirmation 180 is transmitted to the supplier website 110. At 8, the purchased items are then shipped to the customer or the third-party.

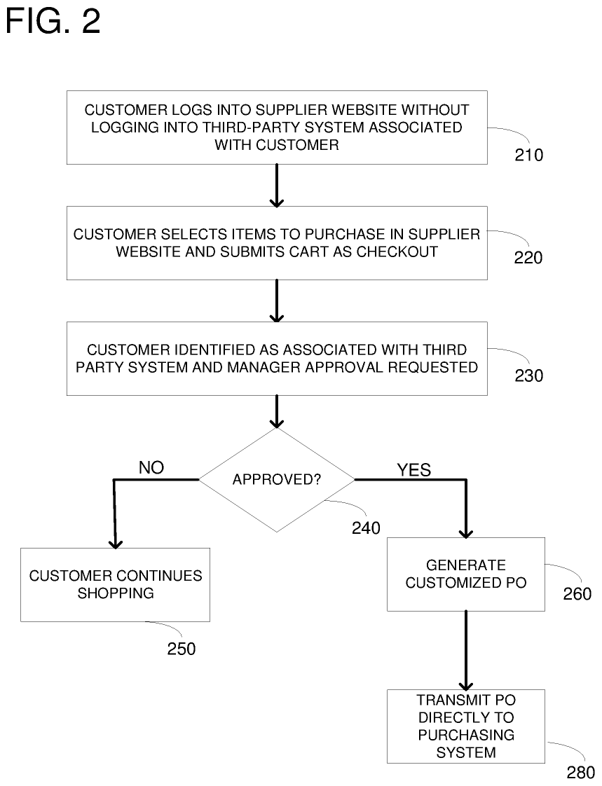

FIG. 2 is a flowchart according to one embodiment for purchasing products on a supplier website. In process block 210, a customer logs into a supplier website without logging into a third-party system associated with the customer. For example, in FIG. 1, the customer client device 112 directly logs in to the supplier website 110 instead of logging into the third-party system 120 and accessing the supplier website 110 via the third-party system. In process block 220, the customer selects items to purchase in the supplier website (which are placed in a shopping cart) and submits the cart at checkout. Thus, in FIG. 1, the customer builds the shopping cart 135 by selecting items to purchase and adding them to the shopping cart. The shopping cart 135 thereby includes a list of products, each of which is associated with a unique identifier. The user can then select an option to checkout. At process block 230, the customer is identified as associated with the third-party system. This can be achieved by searching for the customer in the database 132, as previously described. In decision block 240, a determination can be made whether the customer is approved to purchase the goods. In some cases, approval can be automatic. In other cases, a manager can approve the items to purchase. In either case, if decision block 240 is answered in the negative, then the customer can continue shopping at 250 and possibly exchange problematic items. However, if decision block 240 is answered in the affirmative, then at 260, a customized PO is generated that can include identifiers to the goods and the employee making the purchase. Other fields can also be used. At process block 280, the PO is then transmitted directly to the purchasing system.

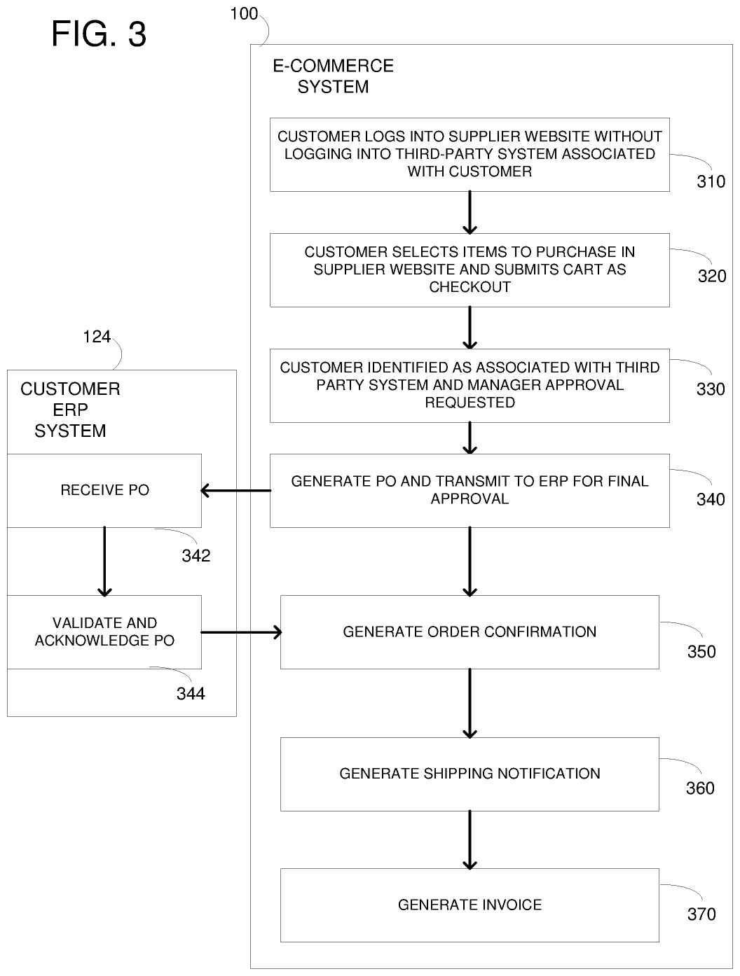

FIG. 3 shows further details of process blocks that can occur in the E-commerce system 100 and the purchasing system 124. In this particular embodiment, the PO is transmitted directly to an ERP system that is within the purchasing system. In process block 310, a customer logs into the supplier website without logging into the third-party system associated with the customer. For example, in FIG. 1, the customer does not need to log into the third-party system 120, and, particularly, does not need to log into the E-procurement system 122. Instead, the customer can log directly into the supplier website 110. At process block 320, the customer selects items to purchase in the supplier website and submits the items as a shopping cart at checkout. At process block 330, the customer is identified as associated with the third-party system and manager approval is requested. For example, in FIG. 1, when the customer logs in, checks out or at some other intermediate point, the supplier website 110 uses the credentials of the customer to check the database 132 to determine whether the customer is associated with the third-party system 120. If so, the settings associated with the customer in the database 132 indicate whether manager approval is required or not. If manager approval of the purchases is required, a message can be sent to the manager that a cart is ready for review in the supplier website 110. In process block 340, the E-commerce system generates a PO and transmits the PO directly to the third-party ERP system. The PO is customized in accordance with the particular ERP system using the customer settings in the database 132 (FIG. 1). Notably, no POOM is generated during the approval process. The third-party administrator can perform a set-up for any of its employees that are making purchases by submitting a PO template that is stored in the database 132. At process block 342, the ERP system receives the PO and processes the PO by determining whether the purchases are acceptable. For example, the PO can include product types and certain product types can be prohibited, such as alcohol. Additionally, the ERP system can determine whether the customer is approved to make any purchases. Still further, budget amounts can be checked to ensure that any individual items or the entire PO is not over a predetermined budget. Any desired checks can be made by the ERP system. Assuming that the PO satisfies the predetermined checks, then at 344, the PO is validated and a transmission to the E-commerce system indicates that the purchases are approved. At process block 350, the E-commerce system 100 generates an order confirmation, such as a confirmation email to the third-party. At process block 360, once the items are shipped, the E-commerce system transmits a shipping notification to the third-party system and further supplies an invoice (process block 370).

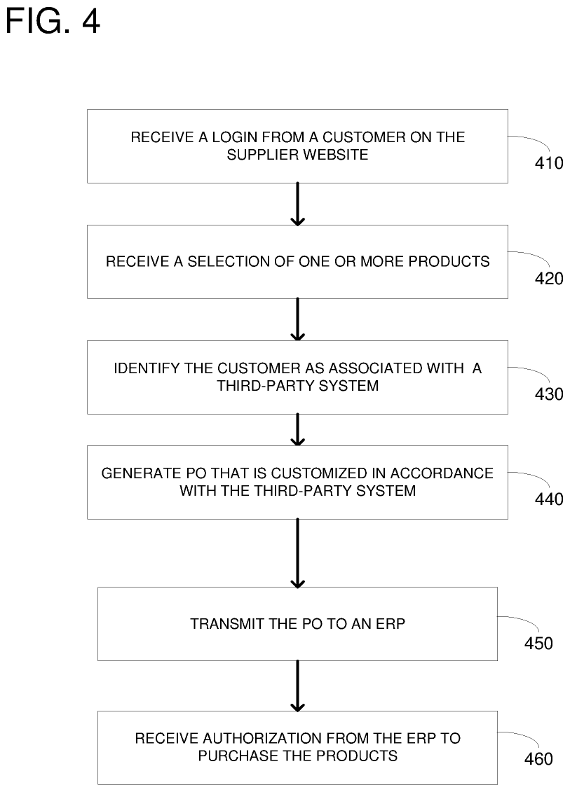

FIG. 4 is a flowchart according to one embodiment for purchasing products on a supplier website. At process block 410, a login is received from a customer on a supplier website. In process block 420, one or more products are selected and placed into an electronic shopping cart on the supplier website. In process block 430, the customer is identified as associated with the third-party system. The customer can use credentials to login to the supplier website, such as a user identifier and password. The supplier website can then use the user identifier to determine that the customer is associated with a third-party system. At process block 440, the supplier website or other associated service in an E-commerce system can generate a PO that is customized in accordance with the third-party system. The PO generally includes identifiers of the products to purchase as well as prices of the products. The PO generally also includes an identifier of the customer making the purchases. Other fields are generally included, such as a project code or other code used by the third-party to track the purchases. In process block 450, the PO is transmitted directly to the ERP system associated with the third-party. The ERP system performs checks on the PO to determine whether the PO conforms to the business settings of the ERP system. In process block 460, authorization is received back in the supplier website from the ERP that the products are authorized to purchase. The supplier website can then complete the purchase and fulfill the order.

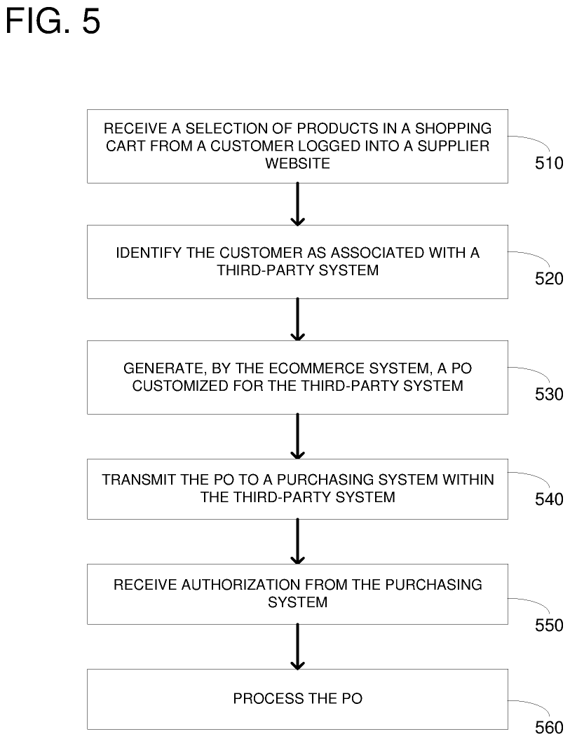

FIG. 5 is a flowchart according to another embodiment for purchasing products on a supplier website. In process block 510, a selection of products is made from a customer logged into a supplier website. The customer can use a mobile device and need not connect with an E-procurement system. The flexibility of allowing the customer to log directly into the supplier website enables the user to order products on behalf of a company on a phone, for example. In process block 520, the customer is identified as associated with a third-party system. Such an identification can occur because the customer logged into a business account using the customer's credentials. In process block 530, an E-commerce system generates a PO. Traditionally, a PO is not generated by an E-commerce system or a supplier website. Instead, it was the third-party system, such as an E-procurement system that generated a PO. In process block 540, the PO is transmitted to the third-party purchasing system for approval. Such a transmission can be directly to an ERP system of the third-party purchasing system. In process block 550, authorization is received from the third party for purchasing the products. In process block 560, the authorized products are processed to deliver the products to the customer. Such a delivery can be considered the customer's place of business or to the customer personally.

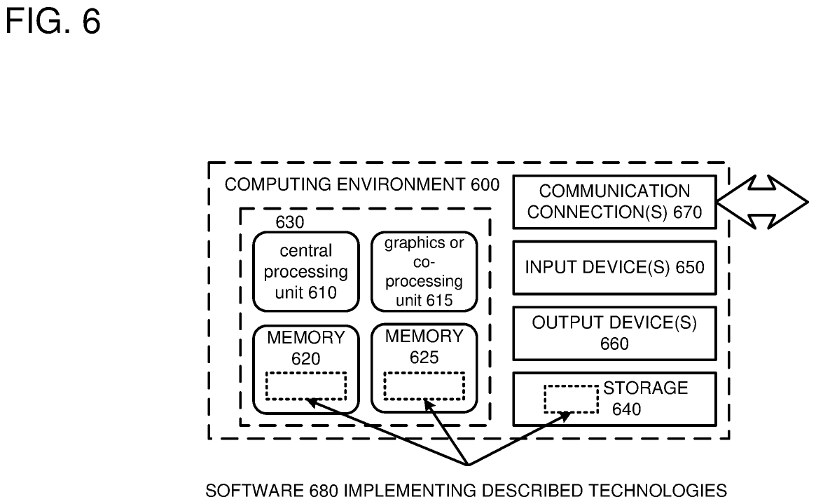

FIG. 6 depicts a generalized example of a suitable computing environment 600 in which the described innovations may be implemented. The computing environment 600 is not intended to suggest any limitation as to scope of use or functionality, as the innovations may be implemented in diverse general-purpose or special-purpose computing systems. For example, the computing environment 600 can be any of a variety of computing devices (e.g., desktop computer, laptop computer, server computer, tablet computer, etc.).

With reference to FIG. 6, the computing environment 600 includes one or more processing units 610, 615 and memory 620, 625. In FIG. 6, this basic configuration 630 is included within a dashed line. The processing units 610, 615 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 6 shows a central processing unit 610 as well as a graphics processing unit or co-processing unit 615. The tangible memory 620, 625 may be volatile memory (e.g., registers, cache, RAM), non-volatile memory (e.g., ROM, EEPROM, flash memory, etc.), or some combination of the two, accessible by the processing unit(s). The memory 620, 625 stores software 680 implementing one or more innovations described herein, in the form of computer-executable instructions suitable for execution by the processing unit(s). In one example, the service 170 can be executing in the computing environment 600.

A computing system may have additional features. For example, the computing environment 600 includes storage 640, one or more input devices 650, one or more output devices 660, and one or more communication connections 670. An interconnection mechanism (not shown) such as a bus, controller, or network interconnects the components of the computing environment 600. Typically, operating system software (not shown) provides an operating environment for other software executing in the computing environment 600, and coordinates activities of the components of the computing environment 600.

The tangible storage 640 may be removable or non-removable, and includes magnetic disks, magnetic tapes or cassettes, CD-ROMs, DVDs, or any other medium which can be used to store information in a non-transitory way and which can be accessed within the computing environment 600. The storage 640 stores instructions for the software 680 implementing one or more innovations described herein.

The input device(s) 650 may be a touch input device such as a keyboard, mouse, pen, or trackball, a voice input device, a scanning device, or another device that provides input to the computing environment 600. The output device(s) 660 may be a display, printer, speaker, CD-writer, or another device that provides output from the computing environment 600.

The communication connection(s) 670 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, aspects of the disclosed technology can be implemented by software written in C++, Java, Perl, any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only examples of the invention and should not be taken as limiting the scope of the invention. We therefore claim as our invention all that comes within the scope of these claims.

1. (canceled)

2. (canceled)

3. (canceled)

4. (canceled)

5. (canceled)

6. A computer-implemented method, comprising:
receiving a selection of one or more products in a shopping cart from a customer logged into a supplier website executed on one or more servers associated with an E-commerce system;
identifying, by the E-commerce system, the customer as associated with a third-party system that is external to the E-commerce system;
retrieving, by the E-commerce system, customer settings data for the customer from a database associated with the E-commerce system;
generating, by the E-commerce system, a custom purchase order (PO) associated with the third-party system using the shopping cart and the customer settings data, wherein the custom PO is generated within the E-commerce system and without using a procurement system of the third-party system;
transmitting, by the E-commerce system, the custom PO to a purchasing system within the third-party system;
receiving, by the E-commerce system, authorization from the purchasing system to purchase the one or more products; and
processing, by the E-commerce system, the custom PO to deliver the one or more products authorized by the purchasing system to the customer.

7. The method of claim 6, wherein the customer is not logged into the third-party system in addition to being logged into the supplier website.

8. The method of claim 6, wherein the custom PO includes fields supplied by the third-party system and stored in the E-commerce system.

9. The method of claim 6, further including determining whether manager approval is needed, and transmitting a message to the manager that the customer has requested approval of the one or more products.

10. The method of claim 6, wherein the purchasing system includes an Enterprise Resource Planning (ERP) system and an E-procurement system.

11. The method of claim 6, wherein the PO includes product types.

12. (canceled)

13. The method of claim 6, wherein the customer settings data comprise a PO template to be used in generation of the PO.

14. One or more non-transitory computer-readable storage media storing computer-executable instructions for causing a computing system to perform a method, the method comprising:
receiving, by an E-commerce system, a login request in a supplier website of the E-commerce system from a customer, without the customer being logged into a third-party system that is external to the E-commerce system;
identifying, by the E-commerce system, the customer as being associated with the third-party system by comparing a customer identifier in the login request to stored identifiers in a database of the E-commerce system;
receiving, by the E-commerce system, a request to purchase products on the supplier web site;
retrieving, by the E-commerce system, customer settings data for the customer from the database;
for the customer associated with the third-party system, generating a purchase order (PO) adapted for the third-party system using the customer settings data, wherein the PO is generated within the E-commerce system and without using a procurement system of the third-party system;
transmitting, by the E-commerce system, the PO to the third-party system;
receiving, by the E-commerce system, an authorization from the third-party system to process the PO; and
processing, by the E-commerce system, the PO.

15. The one or more non-transitory computer-readable storage media of claim 14, wherein the third-party system includes an Enterprise Resource Planning (ERP) system and an E-procurements system.

16. The one or more non-transitory computer-readable storage media of claim 14, wherein the method further comprises:
reading the database to determine whether purchases associated with the customer require manager approval.

17. The one or more non-transitory computer-readable storage media of claim 16, wherein if the manager approval is required, the method further comprises transmitting, by the E-commerce system, a message to the manager that the products to be approved are within a shopping cart of the supplier website.

18. The one or more non-transitory computer-readable storage media of claim 14, wherein the method further comprises:
receiving customer settings data for the customer from the third-party system and storing the customer settings data in the database.

19. The one or more non-transitory computer-readable storage media of claim 18, wherein the customer settings data includes a template for generating the PO adapted for the third-party system.

20. (canceled)

21. A computer system comprising:
one or more processing units coupled to memory; and
one or more computer readable storage media storing instructions that when executed by the one or more processing units cause an E-commerce system to perform operations comprising:
receiving login credentials of a customer through a supplier web site of the E-commerce system;
determining from the login credentials that the customer is associated with a third-party system that is outside of the E-commerce system;
retrieving customer settings data for the customer from a database of the E-commerce system, the customer settings data comprising a purchase order template;
receiving submission of a shopping cart created by the customer on the supplier website, the shopping cart comprising a selection of one or more products for purchase;
generating a custom purchase order for the shopping cart using the purchase order template, wherein the custom purchase order is generated within the E-commerce system and without using a procurement system of the third-party system;
transmitting the custom purchase order to a purchasing system within the third-party system; and
in response to receiving authorization from the purchasing system within the third-party system to process the custom purchase order, processing the custom purchase order to deliver the one or more products to the customer.

22. The computer system of claim 21, wherein the custom purchase order comprises fields supplied by the third-party system and stored in the E-commerce system prior to receiving login credentials of the customer through the supplier website of the E-commerce system.

23. The computer system of claim 21, wherein the instructions when executed by the one or more processing units further cause the E-commerce system to perform operations comprising transmitting a message to a manager to approve the shopping cart, and wherein the customer purchase order is generated in response to receiving approval of the shopping cart from the manager.

24. The computer system of claim 23, wherein the instructions when executed by the one or more processing units further cause the E-commerce system to perform operations comprising determining from the customer settings data whether manager approval is needed prior to transmitting the message to the manager to approve the shopping cart.

25. The computer system of claim 21, wherein transmitting the custom purchase order to the purchasing system within the third-party system comprises the E-commerce system transmitting the custom purchase order directly to the purchasing system.

26. The computer system of claim 21, wherein the instructions when executed by the one or more processing units further cause the E-commerce system to perform operations comprising generating an order confirmation and transmitting the order confirmation to the third-party system.
